(19) United States
(12) Patent Application Publication
(10) Pub. No.: US 2016/0083278 A1
(43) Pub. Date: Mar. 24, 2016

(54) Three-Stage Water Filtration Device

(71) Applicant: Xiamen Runner Industrial Corporation, Xiamen (CN)

(72) Inventors: Mang Lu, Xiamen (CN); Yun-Chuan Wang, Xiamen (CN)

(21) Appl. No.: 14/858,678

(22) Filed: Sep. 18, 2015

(30) Foreign Application Priority Data
Sep. 24, 2014 (CN) 201420548319.3

(51) Int. Cl. C02F 9/00; C02F 1/00; B01D 15/10; B01D 36/02; B01D 61/02

(52) U.S. Cl. CPC C02F 9/00; B01D 36/02; B01D 61/025; B01D 15/10; C02F 1/008; C02F 1/001; C02F 1/283

(57) ABSTRACT

A three-stage water filtration device includes a mounting box, a compound filter cartridge, a RO filter cartridge, a booster pump and an active carbon filter cartridge. Water to be filtered sequentially goes through an inlet of the compound filter cartridge, an inlet and an outlet of the booster pump, an inlet and a filtered water outlet of the RO filter cartridge, an inlet and a filtered water outlet of the active carbon filter cartridge, and a filtered water outlet on the mounting box to get the water filtered. Waste water generated in the RO filter cartridge is drained to sequentially flows through a waste water outlet of the RO filter cartridge and a waste water outlet on the mounting box. Given the foregoing structure, the three-stage water filtration device is compact in size, convenient for assembly and good in filtering effect.

### BACKGROUND OF THE INVENTION

1. Field of the Invention

The present invention relates to a water filtration device and, more particularly, to a three-stage water filtration device.

2. Description of The Related Art

Reverse osmosis (RO) is a water purification technology that uses a semipermeable membrane to remove larger particles from drinking water, so that many house and company will install the RO water purifiers. Good quality purifiers all have a certain size. In view of space limitation, it's inconvenient to install and dismantle a sizable filtration device in a house or in a company.

### SUMMARY OF THE INVENTION

In view of the problems and drawbacks of the prior art, the objective of the present invention is to provides a three-stage water filtration device being compact in size, convenient for assembly and good in filtering effect.

To achieve the foregoing objective, the three-stage filtration device includes a mounting box, a compound filter cartridge, a booster pump, a RO filter cartridge, and an active carbon filter cartridge.

The mounting box is hollow and has a bottom portion formed on a bottom of the mounting box and two lateral portions;

The compound filter cartridge is mounted through the bottom portion of the mounting box and has a compound filtration inlet, a compound filtration outlet.

The compound filtration inlet serves for water entering the compound filter cartridge to flow therein.

The compound filtration outlet serves for water filtered by the compound filter cartridge to exit therefrom.

The booster pump is mounted through the bottom portion of the compound filter cartridge, boosts pressure of water therein to a specific pressure, and has a pump inlet and a pump outlet.

The pump inlet is connected with the compound filtration outlet of the compound filter cartridge through a tube for the water filtered by the compound filter cartridge to flow therein.

The pump outlet serves for the water with the boosted pressure to exit therefrom.

The RO filter cartridge is mounted through the bottom portion of the mounting box and has an RO water inlet, an RO filtered water outlet, and an waste water outlet.

The RO water inlet is connected to the pump outlet of the booster pump through a filtered water pipeline for the water with the pressure boosted by the booster pump to flow therein.

The RO filtered water outlet serves for water filtered by the RO filter cartridge to exit therefrom.

The RO waste water outlet is connected to a waste water outlet formed on the mounting box through the tube for waste water generated by the RO filter cartridge to exit therefrom and flow in the waste water outlet.

The active carbon filter cartridge is mounted through the bottom of the mounting box and has an active carbon filtration inlet and an active carbon filtration outlet.

The active carbon filtration inlet is connected to the RO filtered water outlet through a filtered water pipeline for the water filtered by the RO filter cartridge to flow therein.

The active carbon filtration outlet is connected to a filtered water outlet formed on the mounting box for water filtered by the active carbon filter cartridge to exit therefrom and flow in the filtered water outlet.

When compared to conventional techniques, the present invention has the following advantages, namely, small size, tight structure and good filtering effect. The RO filter cartridge can remove calcium, magnesium, bacteria, organic matter, inorganic matter, metal ions and radioactive substance and water filtered by the three-stage water filtration device is clean and good to drink.

### BRIEF DESCRIPTION OF THE DRAWINGS

The detailed description of the drawings particularly refers to the accompanying figures in which:

FIG. 1 is a first perspective view of a three-stage water filtration device in accordance with the present invention;

FIG. 2 is a partially exploded perspective view of the three-stage water filtration device in FIG. 1;

FIG. 3 is another partially perspective view inside of mounting box with those cartridges and booster pump in FIG. 1;

FIG. 4 is a second perspective view of mounting box the three-stage water filtration device in FIG. 1; and

FIG. 5 is a third perspective view of the mounting box the three-stage water filtration device in FIG. 1 with a top cover removed therefrom.

### DETAILED DESCRIPTION OF THE INVENTION

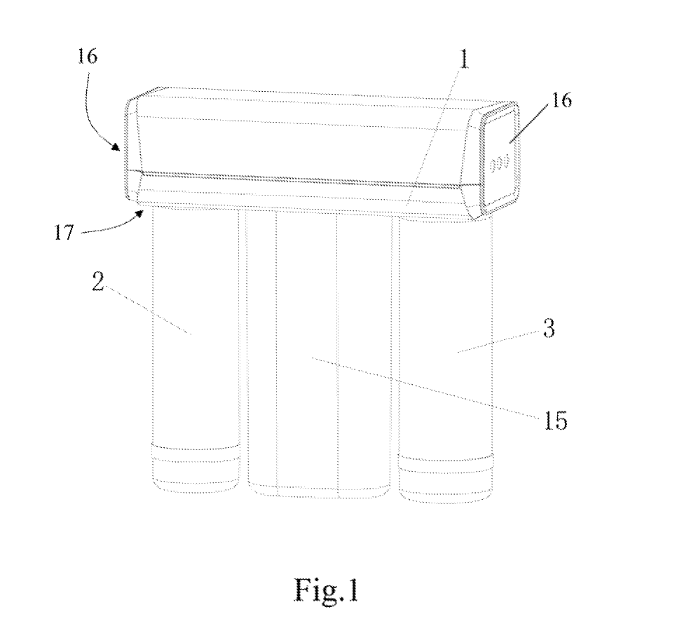

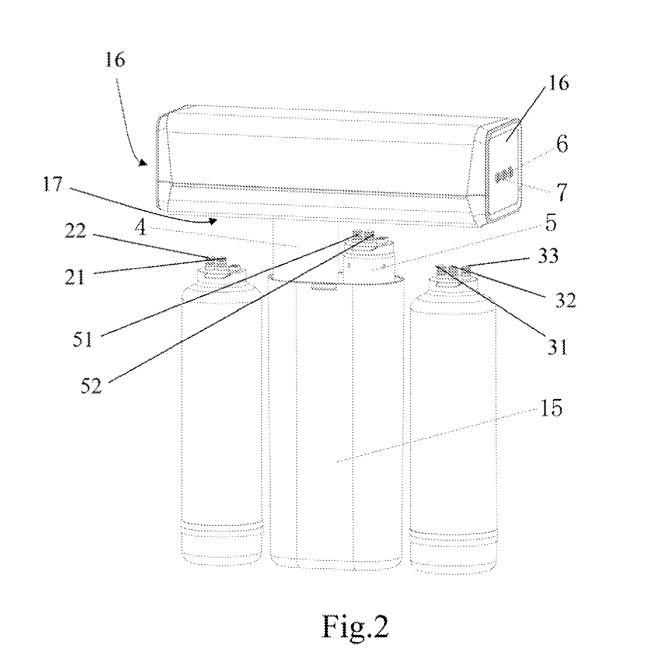

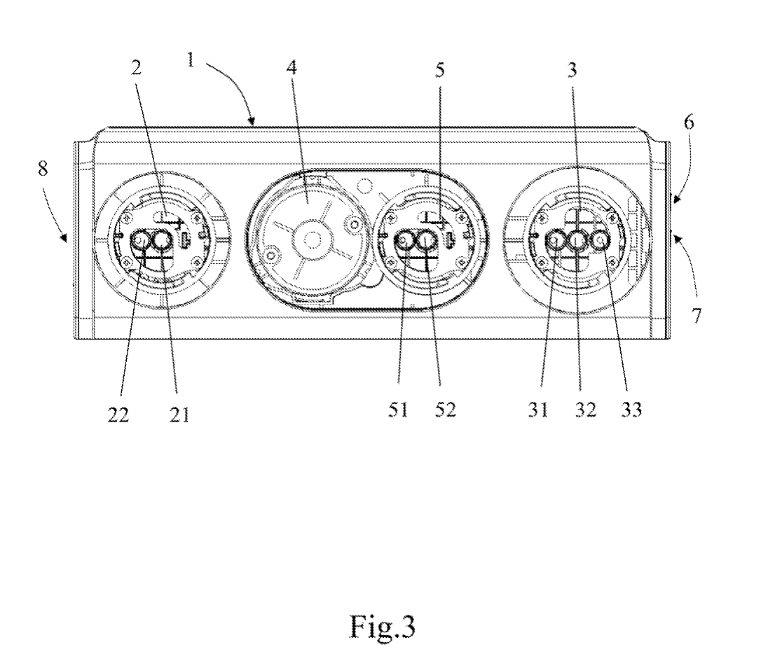

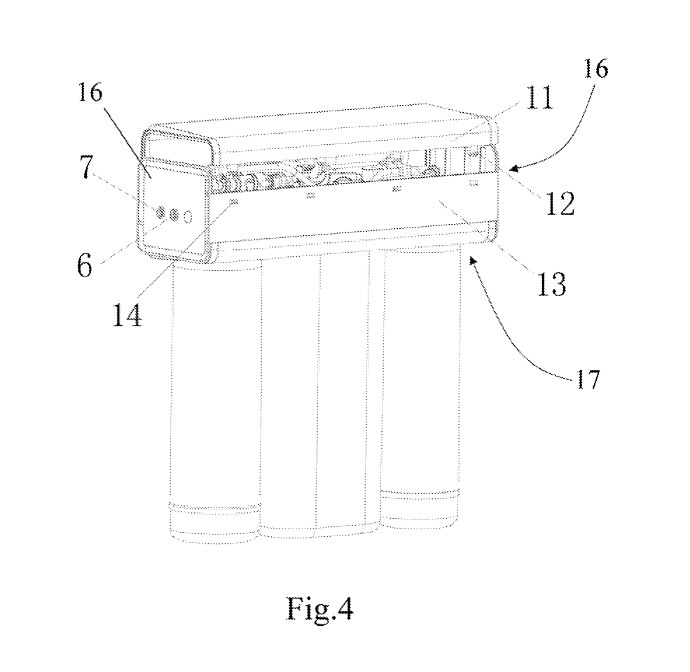

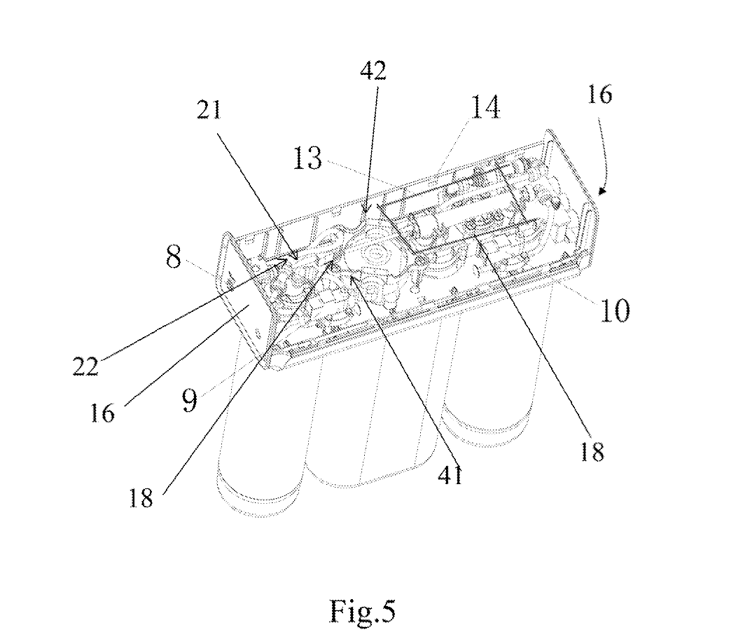

With reference to FIGS. 1-5, a three-stage water filtration device in accordance with the present invention includes a mounting box 1, a compound filter cartridge 2, a booster pump 4, an RO filter cartridge 3 and an active carbon filter cartridge 5.

The mounting box 1 is hollow, is located at a top portion of the three-stage water filtration device, and has a top cover 11, multiple hooks 12, a bottom portion 17, two apron portions 13 and two lateral portions 16. The top cover 11 is formed on a top of the mounting box 1. The multiple hooks 12 are formed around and extend downwards from an edge of the top cover 11. The bottom portion 17 is formed on a bottom of the mounting box 1. Each apron portion 13 is connected between the edge of the top cover and an edge of the bottom portion 17 and has multiple holes 14 formed through the apron portion 13 to correspond to the respective hooks 12 for the hooks 12 to be mounted through the respective holes 14, such that the top cover 11 can be mounted on top edges of the apron portions 13. Each lateral portion 16 is formed on a lateral side of the mounting box 1, is connected with the top cover 11, the apron portions 13 and the bottom portion 17 of the mounting box 1. One of the lateral portions 16 adjacent to the RO filter cartridge 3 has a filtered water outlet 6 and a waste water outlet 7 formed through the lateral portions 16. The other lateral portion has a water inlet 8 formed through the lateral portions 16. Filtered water flows out of the three-stage filtration device through the filtered water outlet 6, and waste water flows out the three-stage filtration device through the waste water outlet 7. Water to be filtered flows in the three-stage filtration device through the water inlet 8. The mounting box 1 further includes a first pressure sensor 9, and a second pressure sensor 10 mounted inside the mounting box 1.

The compound filter cartridge 2, the RO filter cartridge 3 and the active carbon filter cartridge 5 are mounted through the bottom portion 17 of the mounting box 1. The compound filter cartridge 2 compound filtration inlet 21 and a compound filtration outlet 22. The compound filtration inlet 21 is connected with the water inlet 8. The compound filtration outlet 22 is connected with one end of a tube 18.

The booster pump 4 is mounted through the bottom portion 17 of the mounting box 1 with a portion thereof located inside the mounting box 1 and a remaining portion protruding beyond the mounting box 1, is located between the compound filter cartridge 2 and the RO filter cartridge 3, and has a pump inlet 41 and a pump outlet 42. The pump inlet 41 is connected with the compound filtration outlet 22 through the tube 18. The boost pump 4 serves to provide momentum required to supply stable water pressure of water flow into the RO filter cartridge 3.

The RO filter cartridge 3 has a reverse osmosis membrane for filtering impurities of water, and has an RO water inlet 31, an RO filtered water outlet 32 and an RO waste water outlet 33. The RO water inlet 31 is connected with the pump outlet 42 through a filtered water pipeline. Filtered water and waste water outputted from the RO filter cartridge 3 respectively goes to the RO filtered water outlet 32 and the RO waste water outlet 33. The RO waste water outlet 33 is connected with the waste water outlet 7 of the mounting box 1 through the tube 18.

The active carbon filter cartridge 5 contains active carbon therein for purify water, and has an active carbon filtration inlet 51 and an active carbon filtration outlet 52. The active carbon filtration inlet 51 is connected with the RO filtered water outlet 32 through a filtered water pipeline. The active carbon filtration outlet 52 is connected with the filtered water outlet 6 of the mounting box 1 through a filtered water pipeline. A shell 15 is mounted on the bottom portion 17 of the mounting box 1 to enclose the booster pump 4 and the active carbon filter cartridge 5 in the shell 15.

Operation of the three-stage water filtration device is described as follows. Water to be filtered enters the water inlet 8 of the mounting box 1, flows in the compound filter cartridge 2 through the compound filtration inlet 21. Water filtered by the compound filter cartridge 2 flows out of the compound filter cartridge 2 through the compound filtration outlet 22, then flows in the booster pump 4 through the pump inlet 41. After the pressure of water in the booster pump 4 is boosted to be stable, water flows out of the booster pump 4 through the pump outlet 42 and then enters the RO filter cartridge 3 through the RO water inlet 31. Impurities in water passing through the osmosis membrane are removed and the filtered water flows out of the RO filtered water outlet 32. Meanwhile, water containing impurities flows to the er waste water outlet 7 of the mounting box 1 through the RO waste water outlet 33. Filtered water flow from the RO filtered water outlet 32 enters the active carbon filter cartridge 5 through the active carbon filtration inlet 51. Reacted with active carbon inside the active carbon filter cartridge 5, chlorine in the water is neutralized. Filtered water flowing out of the active carbon filtration outlet 52 further flows to the filtered water outlet 6 of the mounting box 1.

The first pressure sensor 9 is mounted on the tube 18 connected between the water inlet 8 of the mounting box 1 and the compound filtration inlet 21 to measure the pressure of water flowing between the water inlet 8 and the compound filtration inlet 21.

The second pressure sensor 10 is mounted on the filtered water pipeline connected between the RO filtered water outlet 32 of the RO filter cartridge 3 and the active carbon filtration inlet 51 of the active carbon filter cartridge 5 to measure the pressure of water flowing between the RO filtered water outlet 32 and the active carbon filter cartridge 5.

Both the first pressure sensor 9 and the second pressure sensor 10 can sense the pressure of water flow, and transfer signal to a microcontroller unit (MCU) in the booster pump 4 to control electrical operation of the booster pump 4.

The three-stage water filtration device is small in size and has a compact structure and good filtering effect. The pipelines of the present invention are all mounted inside of the mounting box 1, because of that, those pipelines are closely connected together. And compare size of prior art filtration device and present invention, present invention size is smaller then prior art, and save install space in house or in company. With the RO filter cartridge 3 calcium, magnesium, bacteria, organic matter, inorganic matter, metal ions and radioactive substance etc. in water can be removed through the three-stage water filtration device and water filtered by the three-stage water filtration device is clean and good to drink.

1. A three-stage water filtration device including:
a mounting box being hollow and having a bottom portion formed on a bottom of the mounting box and two lateral portions; a compound filter cartridge mounted through the bottom portion of the mounting box and having:
a compound filtration inlet serving for water entering the compound filter cartridge to flow therein; and
a compound filtration outlet serving for water filtered by the compound filter cartridge to exit therefrom;
a booster pump mounted through the bottom portion of the compound filter cartridge, boosting pressure of water therein to a specific pressure, and having:
a pump inlet connected with the compound filtration outlet of the compound filter cartridge through a tube for the water filtered by the compound filter cartridge to flow therein; and
a pump outlet serving for the water with the boosted pressure to exit therefrom; a RO (Reverse Osmosis) filter cartridge mounted through the bottom portion of the mounting box and having:
an RO water inlet connected to the pump outlet of the booster pump through a filtered water pipeline for the water with the pressure boosted by the booster pump to flow therein;
an RO filtered water outlet serving for water filtered by the RO filter cartridge to exit therefrom; and
an RO waste water outlet connected to a waste water outlet formed on the mounting box through the tube for waste water generated by the RO filter cartridge to exit therefrom and flow in the waste water outlet; and
an active carbon filter cartridge mounted through the bottom of the mounting box and having:
an active carbon filtration inlet connected to the RO filtered water outlet through a filtered water pipeline for the water filtered by the RO filter cartridge to flow therein; and
an active carbon filtration outlet connected to a filtered water outlet formed on the mounting box for water filtered by the active carbon filter cartridge to exit therefrom and flow in the filtered water outlet.

2. The three-stage water filtration device as claimed in claim 1, wherein a water inlet is formed on one of the lateral portions of the mounting box adjacent to the compound filter cartridge and is connected with the compound filtration inlet for water from an external water source to flow therein, the other lateral portion adjacent to the RO filter cartridge has the filtered water outlet and the waste water outlet formed thereon.

3. The three-stage water filtration device as claimed in claim 2, wherein the mounting box includes:
a first pressure sensor mounted on the tube between the water inlet of the mounting box and the compound filtration inlet of the compound filter cartridge; and
a second pressure sensor mounted on the filtered water pipeline between the RO filtered water outlet of the RO filter cartridge and the active carbon filtration inlet of the active carbon filter cartridge.

4. The three-stage water filtration device as claimed in claim 1, wherein the mounting box further has:
a top cover formed on a top of the mounting box;
multiple hooks formed around and extending downwards from an edge of the top cover; and
two apron portions, each apron portion connected between the edge of the top cover and an edge of the bottom portion of the mounting box and having multiple holes formed through the apron portion to correspond to the respective hooks for the hooks to be mounted through the respective holes and for the top cover to be mounted on top edges of the apron portions;
wherein each lateral portion of the mounting box is formed on a lateral side of the mounting box, is connected with the top cover, the apron portions and the bottom portion of the mounting box.

5. The three-stage water filtration device as claimed in claim 1, wherein the booster pump and the active carbon filter cartridge are mounted into a shell mounted on the bottom portion of the mounting box.
